(19) United States
(12) Patent Application Publication
(10) Pub. No.: US 2006/0130529 A1
(43) Pub. Date: Jun. 22, 2006

(54) Methods and apparatus for processing soot articles

(76) Inventors: Dana C. Bookbinder, Corning, NY (US); Amy L. Rovelstad, Ithaca, NY (US)

Correspondence Address: CORNING INCORPORATED, SP-TI-3-1, CORNING, NY, 14831, US

(21) Appl. No.: 11/018,727

(22) Filed: Dec. 20, 2004

(51) Int. Cl. C03B 37/023; C03B 32/00

(52) U.S. Cl. 65/394; 65/399; 65/426; 65/32.1; 65/30.13

(57) ABSTRACT

A method for processing a silica-containing soot article includes exposing a silica-containing soot article to a removal gas including bromine such that the removal gas removes chlorine from the soot article.

### FIELD OF THE INVENTION

The present invention relates to methods and apparatus for processing soot articles and, more particularly, to methods and apparatus for removing chlorine from soot articles.

### BACKGROUND OF THE INVENTION

An optical waveguide or fiber may be drawn from a consolidated glass preform. The glass preform may be formed by sintering a soot preform. Soot preforms may be formed by suitable methods such as, for example, chemical vapor deposition (CVD).

Removal of unwanted chemical species may be an important step in the preparation of soot preforms for optical fibers, lithography photomask plates, lenses and the like. Typical unwanted species include water (i.e., H₂O and OH) and transition metals. This problem may be addressed by implementation of one or more drying and purification process steps, wherein a chlorine-containing drying gas is flowed through and about the porous soot preform. The drying gas may strip both transition metals and water. However, a problem associated with such drying processes is that residual chlorine atoms may remain in and/or on the soot preform and ultimately in the sintered glass preform. Such residual chlorine may negatively affect the performance of the optical fiber or other glass product. In an effort to remove chlorine from soot preforms, a flow of O₂ has been used to displace or flush chlorine from the soot preform, but this approach may have limited effectiveness and may serve to reintroduce water or other impurities into the soot preform through the presence of tramp material in the O₂ gas.

### SUMMARY OF THE INVENTION

According to method embodiments of the present invention, a method for processing a silica-containing soot article, such as a preform, includes exposing a silica-containing soot article to a removal gas including bromine such that the removal gas removes chlorine from the soot article.

According to some embodiments, the method further includes exposing the soot article to a chlorine-containing drying gas prior to exposing the soot article to the removal gas.

According to some embodiments, the method further includes: forming a soot article using a vapor deposition process prior to exposing the soot article to the drying gas; consolidating the soot article to form a consolidated glass preform following exposing the soot article to the removal gas; and thereafter drawing an optical fiber from the consolidated glass preform. An alkali metal may be diffused into the consolidated glass preform or a portion thereof prior to drawing the optical fiber from the consolidated glass preform.

According to some embodiments, the method further includes forming a photomask or lens blank from the consolidated glass article.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a flowchart representing method embodiments for processing a soot article in accordance with the present invention;

FIG. 2 is a flowchart representing more particular method embodiments for processing a soot preform in accordance with the present invention;

FIG. 3 is a schematic view of a soot preform processing apparatus according to embodiments of the present invention;

FIG. 4 is a cross-sectional view of a multilayer glass preform formed using a method according to embodiments of the present invention;

FIG. 5 is a perspective view of a photomask or lens blank formed using a method according to embodiments of the present invention; and

FIG. 6 is a perspective view of a tubular glass preform formed using a method according to the present invention, and which may be used to form the photomask or lens blank of FIG. 5.

### DETAILED DESCRIPTION OF THE EMBODIMENTS OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As used herein, “ppm” refers to parts per million by weight.

As used herein, “drying atmosphere” refers to an atmosphere including a “drying gas”. “Drying gas”, as used herein, refers to a gas including a desired and suitable drying agent (i.e., compound for drying, namely, removing water and hydroxyl ions in a soot article such as a soot preform).

Methods and apparatus according to the present invention may be used to remove chlorine (partially or entirely) from a soot article such as a soot preform. Methods and apparatus according to the present invention may also be used to dry a soot article such as a soot preform.

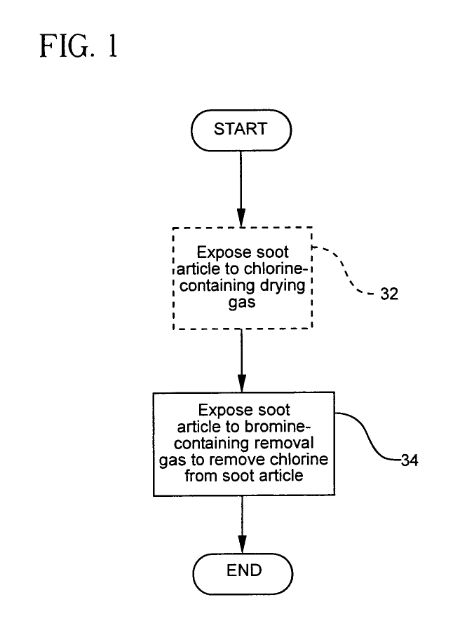

In accordance with embodiments of the present invention and with reference to FIG. 1, a method for processing a silica-containing soot article, for example a soot perform, includes exposing the soot article to a bromine-containing removal gas such that the removal gas, and more particularly the bromine (Br) therein, removes chlorine (Cl) from the soot article (Block 34; generally, the “removal step”). The method may optionally further include exposing the soot article to a chlorine-containing drying gas (Block 32) to dry the soot article prior to exposing the soot article to the removal gas. The method may further include sintering the de-chlorinated soot article to form a consolidated glass article such as a consolidated glass preform. A glass product such as an optical fiber or a photomask or lens blank may be formed from the consolidated glass article.

According to some embodiments, the soot article includes at least about 1000 parts per million (ppm) chlorine at the beginning of the removal step. According to some embodiments, the soot article includes between about I 000 and 2000 ppm chlorine at the beginning of the removal step.

According to some embodiments, the removal step reduces the amount of chlorine in the soot article by at least about 900 ppm chlorine. According to some embodiments, the removal step reduces the amount of chlorine in the soot article by between about 900 and 2000 ppm chlorine.

According to some embodiments, the removal step reduces the amount of chlorine in the soot article to no more than about 500 ppm chlorine, preferably no more than about 100 ppm chlorine, and more preferably no more than about 10 ppm chlorine. According to some embodiments, the removal step substantially fully de-chlorinates the soot article to provide a chlorine-free soot article (e.g., soot preform), meaning the soot article includes no more than about 1 ppm chlorine.

According to some embodiments, the soot article is consolidated (e.g. sintered) after the removal step to form a consolidated glass article and the consolidated glass article includes no more than about 100 ppm bromine, in some cases, no more than 1 ppm, and in some cases, no more than about 0.1 ppm bromine. According to some embodiments, the consolidated preform includes no more than about 0.01 ppm bromine. According to some embodiments, the consolidated glass article includes no greater than about 1 weight % bromine.

According to some embodiments, the bromine-containing removal gas includes Br₂.

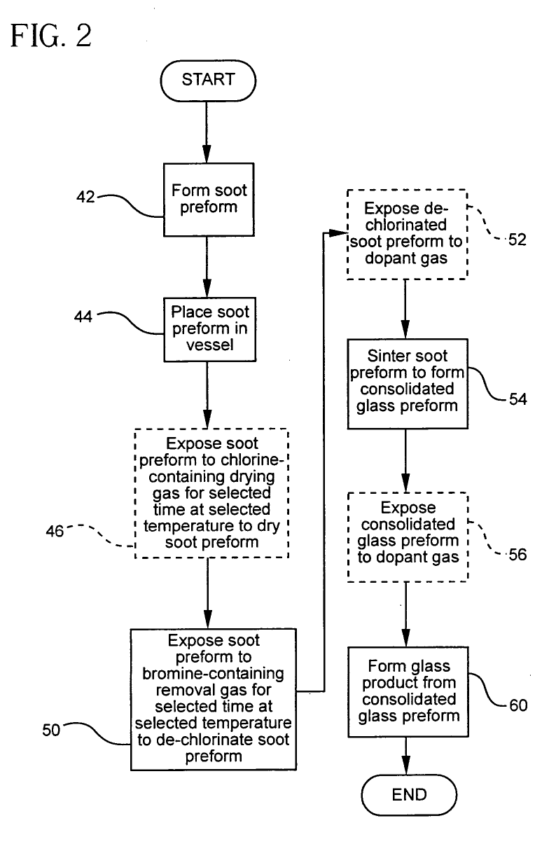

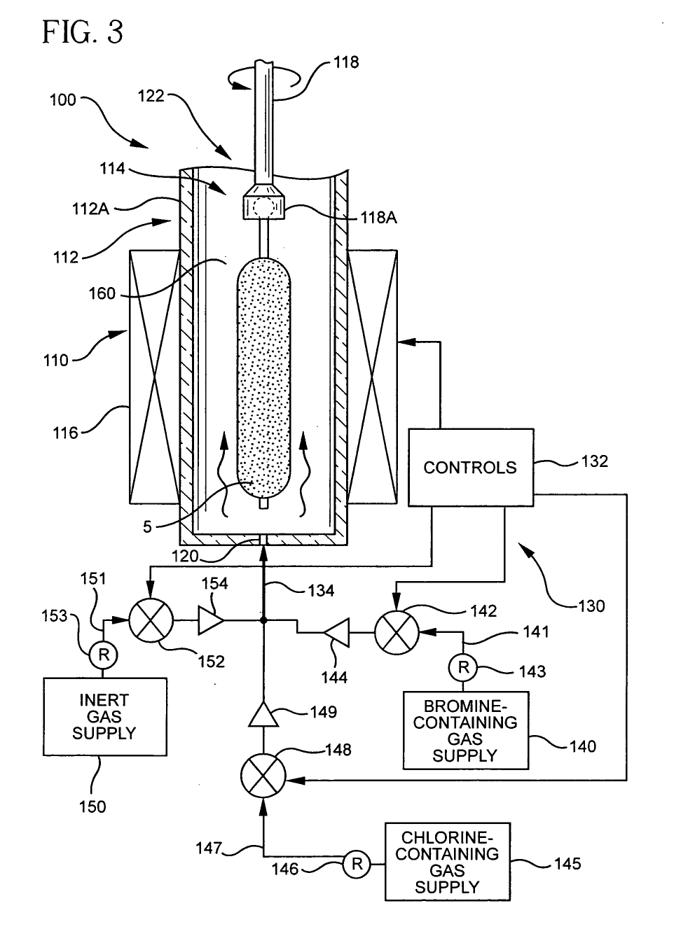

More particular method embodiments of the present invention for processing a soot article or preform 5 (see FIG. 3) and forming a glass product (e.g., an optical waveguide or photomask or lens blank) therefrom are represented by the flowchart of FIG. 2. A soot preform processing apparatus 100 according to embodiments of the present invention is shown in FIG. 3 and may be used to execute the methods of FIGS. 1 and 2. It will be appreciated that the methods may be executed using other apparatus. The apparatus 100 will be described immediately below, followed by descriptions of methods according to the present invention for processing a soot preform and forming a glass product.

The apparatus 100 includes a furnace 110 and a fluid control system 130. The furnace 110 includes a vessel 112. The vessel 112 includes an annular muffle 112A. The vessel 112 defines a chamber 114 that has an inlet 120 and an outlet 122, each in fluid communication with the chamber 114. The vessel 112 may be formed of pure quartz. According to some embodiments, substantially all of the portions or surfaces of the vessel 112 that interface with the chamber 114 are formed of quartz.

A quartz handle 118 extends downwardly into the chamber 114 as shown. The handle 118 has a coupling portion 118A from which the soot preform 5 is removably suspended. A motor (not shown) may be provided to rotate the handle 118 and the attached preform 5.

A heating device 116 partially or fully surrounds a portion of the muffle 112A. The heating device 116 may be, for example, a resistive or inductive heater, or any other suitable heating device. The heating device 116 should provide sufficient heat to accomplish the process steps of drying and chlorine removal as described herein. The heating device 116 may also be adapted to provide sufficient heat to accomplish the process steps of doping and/or sintering as described herein.

The fluid control system 130 includes suitable controls 132 that may be automatically, manually or semi-automatically operated. The system 130 further includes a supply 140 of bromine-containing gas, a supply 145 of chlorine-containing gas, and a supply 150 of a carrier or inert gas. The supplies 140, 145, 150 are pressurized and have respective pressure regulators 143, 146 and 153. Conduits or lines 141, 147, and 151 connect the supplies 140, 145, 150 to a common inlet line 134 that fluidly communicates with the inlet 120 and thereby the chamber 114. A controllable on/off valve 142 and a check valve 144 are provided in the line 141. Similarly, controllable on/off valves 148, 152 and check valves 149, 154 are provided in the lines 147, 151. The controls 132 are operable to open and close the valves 142, 148 and 152.

Gases exiting the chamber 114 through the opening 122 may be directed to a scrubber, for example. The scrubber may be any suitable device or devices for treating or recycling the gases or portions of the gases exhausted from the chamber 114 as described hereinbelow.

In accordance with methods according to the present invention and with reference to FIG. 2, a soot preform (e.g., the soot preform 5) is formed (Block 42). The soot preform 5 may be formed using any suitable method, such as chemical vapor deposition (CVD) (e.g., outside vapor deposition (OVD), vapor axial deposition (VAD), modified chemical vapor deposition (MCVD), plasma chemical vapor deposition (PCVD)) or any other suitable technique such as sol-gel processing. For example, U.S. Pat. No. 3,933,454 discloses suitable methods and apparatus for forming a soot preform. The soot preform 5 may be formed of pure silica or may be formed of doped silica (for example, silica doped with a suitable dopant or dopants including, but not limited to, germania, boron, fluorine, antimony, erbium, aluminum, titanium, tantalum and/or chlorine). The soot preform 5 is a porous structure defining a plurality of interstices. The soot preform 5 may include a passage extending the full length thereof from which a mandrel of the chemical vapor deposition apparatus has been removed. According to some embodiments, the soot preform 5 has a density of less than about 1 g/cc, preferably less than about 0.8 g/cc, and more preferably from about 0.2 to 0.8 g/cc.

In accordance with drying methods according to the invention and with reference to FIG. 2, the soot preform 5 is placed in the chamber 114 of the vessel 112 and suspended from the handle 118 (Block 44).

Optionally, the perform 5 may be dried. Using the fluid control system 130, a chlorine-containing drying gas is supplied to the chamber 114 and flowed about the soot preform 5 so that the soot preform 5 is exposed to the drying gas (Block 46). More particularly, the valves 148 and 152 are opened to form a drying gas including desired proportions of the inert gas from the supply 150 and the chlorine-containing gas from the chlorine-containing gas supply 145 in the line 134. The pressures from the supplies 140, 145 force the drying gas into the chamber 114, thereby providing the drying gas to the vessel.

The controls 132 maintain the valves 148, 152 open and operate the heating device 116 to flow the drying gas through the chamber 114 and to heat the drying gas to a selected drying temperature for a selected drying reacting time. The drying gas flows through and diffuses into the porous soot preform 5 where it reacts with and removes or strips away water (H₂O), hydroxyl ions (OH⁻), and/or transitional metals from the soot preform 5. The drying gas including the removed water and other contaminants continues to flow through and out of the muffle 112 so that the water and contaminants are thereby permanently removed from the soot preform 5. In this manner, the soot preform 5 is partially or fully dried as desired. However, as discussed above, chlorine atoms from the drying gas or otherwise may occupy sites on the surface of the soot preform and/or in pores of the soot preform 5. At the end of the drying time, the valves 148, 152 are then closed to terminate the flow of drying gas into the chamber 114.

Suitable chlorine-containing gases in supply 145 may include Cl₂, SiCl₄, GeCl₄, SOCl₂, COCl₂ and/or POCl₃. According to some embodiments, the mole % of chlorine in the drying gas is between about 1 and 10%. Suitable inert gases from the inert gas supply 150 may include He, Ar, Ne and/or N₂. According to some embodiments, the valve 152 remains closed so that the drying gas includes only the chlorine-containing gas from the supply 145.

The concentration of chlorine in the drying gas, the drying temperature and the drying reacting time are selected to provide a selected level of drying to the soot preform 5. According to some embodiments, the drying temperature is between about 900 and 1200° C. According to some embodiments, the drying temperature is less than about 1200° C. throughout the reacting time. The drying temperature may be constant or varied. According to some embodiments, the reacting time for drying is between about 30 and 300 minutes. According to some embodiments, the drying gas is provided at a flow rate through the chamber 114 of between about 0.1 and 1 slpm.

The foregoing steps of Block 46 may be repeated in a one or more additional drying cycles. In this manner, the preform 5 is further dried by the chlorine of the drying gas. According to some embodiments, the one or more additional drying cycles are performed in the same apparatus 100 and the preform 5 is retained in the chamber 114 between each of the drying cycles. One or more of the parameters of the drying step (Block 46) may be modified. For example, the pressure, the temperature, the chlorine-containing gas, the relative proportions of the chlorine-containing and inert gases, and/or the drying reacting time may be different from those of the first cycle.

A flow of the inert gas from the supply 150 or other suitable gas may be passed through the vessel 112 to purge the chamber 114 between each drying cycle (if multiple cycles are used) and/or at the end of the reacting time of the last drying cycle.

According to some embodiments, the soot preform 5 is substantially water-free (i.e., less than about 0.1 ppm water) following the last drying cycle.

According to some embodiments, the drying cycle or cycles cumulatively impart between about 1000 and 2000 additional ppm chlorine to the soot preform. According to some embodiments, the soot preform includes at least 1000 ppm chlorine at the end of the last drying cycle and upon initiation of the removal step described below.

Following the drying step and using the fluid control system 130, a bromine-containing removal gas is supplied to the chamber 114 and flowed about the soot preform 5 so that the soot preform 5 is exposed to the removal gas (Block 50). More particularly, the valves 142, 152 are opened to form a removal gas including desired proportions of the inert gas from the supply 150 and the bromine-containing gas from the bromine-containing gas supply 140 in the line 134. The pressures from the supplies 140, 150 force the removal gas into the chamber 114, thereby providing the removal gas to the vessel. In some embodiments, the valve 152 may remain closed so that the removal gas includes only the bromine-containing gas.

The controls 132 maintain the valves 142, 152 open and operate the heating device 116 to flow the removal gas through the chamber 114 and to heat the removal gas to a selected removal temperature for a selected removal reacting time. The removal gas flows through the interstices of and penetrates or diffuses into the porous soot preform 5 where it reacts with and removes or strips away chlorine from the soot preform 5. The bromine of the removal gas serves as a getter for chlorine in the soot. In one example as shown below, Br₂ is hypothesized to react with the chlorine according to the equations:
Br₂+Cl₂=2BrCl
2(≡Si—Cl)+Br₂(g)=>≡Si—Si≡+2BrCl
2(≡Si—OCl)+Br₂=>≡Si—O—O—Si+2BrCl

Thus, the volatile compound BrCl, and possibly other byproducts, may be formed. The removal gas may also react with and remove or strip away H₂O, OH⁻, and/or transitional metals from the soot preform 5. The removal gas including the removed chlorine, water and other contaminants continues to flow through and out of the muffle 112 so that the chlorine, water and contaminants are thereby permanently removed or swept away from the soot preform 5. In this manner, the soot preform 5 is partially or fully de-chlorinated as desired. Bromine atoms from the removal gas may occupy sites on the surface of the soot preform and/or in pores of the soot preform 5. At the end of the removal time, the valves 142, 152 are then closed to terminate the flow of removal gas into the chamber 114.

Suitable removal gases include bromine-containing species. Suitable bromine-containing gases in the supply 140 may include, for example, Br₂, SiBr₄, COBr₂, CBr₄, S₂Br₂, CHBr₃, CH₂Br₂, CH₃Br, and/or combinations thereof. According to some embodiments, the mole % of bromine in the removal gas is at least about 0.1%, and more preferably, at least about 1%. According to some embodiments, the mole % of bromine in the removal gas is between about 1 and 10%. Suitable inert gases from the inert gas supply 150 may include He, Ar, Ne and/or N₂. According to a preferred embodiment, the bromine-containing removal gas is a mixture of Br₂ and He. According to some embodiments, the valve 152 remains closed so that the removal gas includes only the bromine-containing gas from the supply 140.

The concentration of bromine in the removal gas, the removal temperature and the removal reacting time are selected to provide a selected level of de-chlorination to the soot preform 5. According to some embodiments, the removal temperature is between about 900 and 1200° C. According to some embodiments, the removal temperature is less than about 1200° C. throughout the removal reacting time. The removal temperature may be constant or varied. According to some embodiments, the removal reacting time is between about 30 and 300 minutes. According to some embodiments, the removal gas is provided at a flow rate through the chamber 114 of between about 0.1 and 1 slpm.

The foregoing steps of Block 50 may be repeated in one or more additional removal cycles. In this manner, the preform 5 is further de-chlorinated by the bromine of the removal gas. According to some embodiments, the one or more additional removal cycles are performed in the same apparatus 100 and the preform 5 is retained in the chamber 114 between each of the removal cycles. One or more of the parameters of the removal step (Block 50) may be modified. For example, the pressure, the temperature, the bromine-containing gas, the relative proportions of the bromine-containing gas and the inert gas, and/or the reacting time may be different from those of the first cycle.

A flow of the inert gas from the supply 150 or other suitable gas may be passed through the vessel 112 to purge the chamber 114 between each removal cycle (if multiple cycles are used) and/or at the end of the reacting time of the last removal cycle.

According to some embodiments, the removal cycle or cycles cumulatively reduce the amount of chlorine in the soot preform 5 by the amounts discussed above with reference to FIG. 1.

The dried, de-chlorinated soot preform 5 may thereafter be optionally doped by flowing a dopant gas (alone or with inert gas from the inert gas supply 150) through the chamber 114 and about the soot preform 5 (Block 52). The dopant gas may be any suitable gas. The dopant gas may be a halogen-containing gas such as a fluorine-containing gas, SiCl₄, SiF₄, SF₆, CF₄, C₂F₆, COF₂, C₂F₂Cl₂, and example.

Following and/or during the doping step of Block 52 or, if no doping is desired, the last removal step, the soot preform 5 may be sintered to form a consolidated glass preform (Block 54). The sintering step may include heating the soot preform 5 in the chamber 114 using the heating device 116 and/or another heating device to sinter the soot preform 5 using known or other suitable techniques. According to some embodiments, the sintering step includes heating the soot preform 5 to a temperature of at least about 1450° C. According to some embodiments, the sintering step includes heating the soot preform 5 to a temperature of between about 1300 and 1800° C.

The consolidated glass preform may thereafter be optionally doped by flowing a dopant gas (alone or with inert gas from the inert gas supply 150) through the chamber 114 and about the consolidated glass preform (Block 56). The dopant gas may be any suitable gas. According to some embodiments, the dopant gas includes an alkali metal as a doping agent. The alkali metal or other doping agent may diffuse through the surface of, and into, the consolidated glass preform. According to some embodiments, the alkali metal is selected from the group consisting of K, Na, Li, Cs, Rb, and combinations thereof. According to some embodiments, the dopant, the doping process, and/or related parameters and steps are as disclosed in United States Patent Application Publication No. US 2004/0057692 A1, published Mar. 25, 2004, the disclosure of which is incorporated herein by reference in its entirety.

According to some embodiments, the preform is retained in the chamber 114 throughout and between each of the drying step(s) (if any), the removal step(s), the soot preform doping step(s) (if any), the sintering step, and the consolidated glass preform doping step (if any).

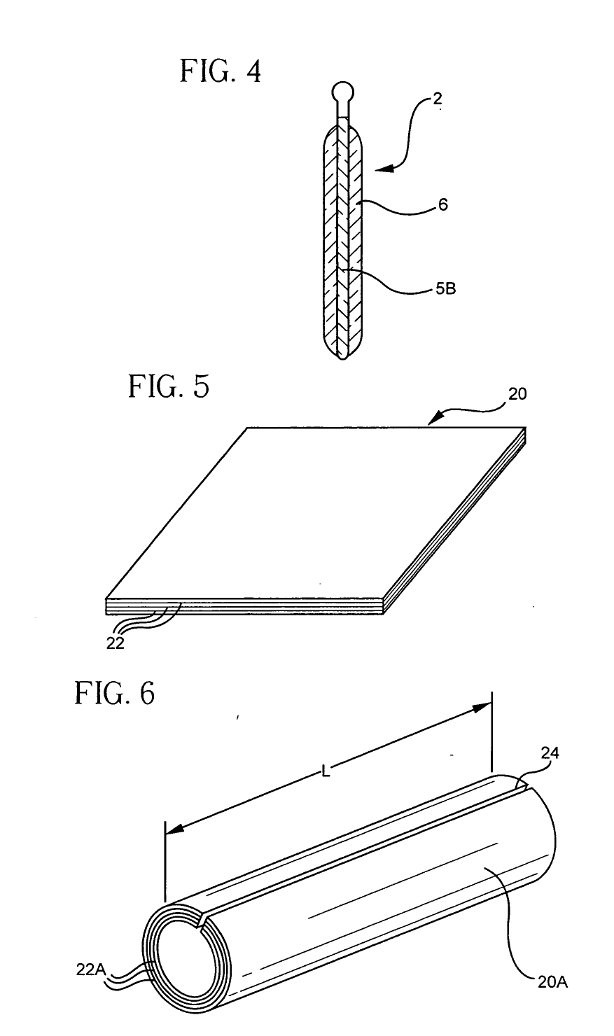

A glass product is thereafter formed from the consolidated glass preform (Block 60). According to some embodiments, the glass product is an optical waveguide. In known manner, the consolidated glass preform may be drawn and sectioned to form a glass cane. A further layer of glass may be added to the glass cane to form a multilayer optical fiber preform 2 as shown in FIG. 4. The multilayer optical fiber preform 2 includes the glass cane as a core 5B thereof and an additional glass layer 6 as a cladding or further core layer thereof. The layer 6 may be doped or undoped. The outer layer 6 may be formed by depositing an outer soot layer about the glass cane 5B using a suitable deposition method such as OVD. The outer soot layer may in turn be processed in the same or a different manner than described above to form a multi-layered glass preform. For example, the outer soot layer may be dried using a chlorine-containing drying gas and may also be de-chlorinated using a bromine-containing gas. The outer soot layer is likewise consolidated. Alternatively, the glass cane SB may be sleeved with a glass tube.

An optical glass fiber may thereafter be drawn from the multilayer optical fiber preform 2 using any suitable technique and apparatus. Suitable techniques and apparatus for drawing optical fiber from a consolidated glass preform are described in U.S. Pat. No. 4,101,300, U.S. Pat. No. 4,126,436, U.S. Pat. No. 4,154,592, U.S. Pat. No. 4,284,499, and U.S. Pat. No. 5,320,658, for example. It will be appreciated that the glass preform core 5B of the optical fiber preform 2 will form the core of the optical fiber and the outer glass layer 6 of the optical fiber preform 2 will form a cladding or further core layer of the optical fiber. As discussed above, the core may include an alkali metal doping.

According to some embodiments, the optical fiber formed by methods in accordance with the present invention is a low loss fiber, meaning the fiber exhibits an optical attenuation less than about 0.18 dB/km at a wavelength of 1550 nm.

According to other embodiments, methods according to the present invention may be used to form an optical lithography photomask or lens blank 20 as illustrated in FIG. 5. The blank 20 may be formed using any suitable technique and suitable modifications to the method described above with reference to FIGS. 2 and 3 will be apparent to those of skill in the art in view of the description herein. Suitable techniques for forming a photomask or lens blank from a glass preform are disclosed in U.S. Pat. No. 6,689,516 to Berkey et al., the disclosure of which is incorporated herein by reference. By way of example, the glass preform may be formed as a tubular glass preform 20A and a cut 24 may be formed along its length L as shown in FIG. 6. The cut preform is heated and flattened to form the photomask blank 20. Alternatively, the tubular glass preform may be cut into multiple pieces by multiple lengthwise cuts and each piece may be heated and flattened. Alternatively, the glass preform may be collapsed. The soot preform may be formed so as to have multiple, concentric layers of soot. When the soot preform is consolidated to form the glass preform 20A, the glass preform 20A may include concentric layers 22A of glass, which in turn correspond to multiple stacked, fused layers 22 of glass in the blank 20. The glass preform may be divided, mined, and/or finished (e.g., polished, ground and lapped, etc.) to form one or more photomask or lens blanks therefrom.

According to some embodiments, the photomask or lens blank is adapted for use in photolithography systems utilizing vacuum ultraviolet light (VUV) wavelengths of 193 nm and below, and in accordance with some embodiments, in the 157 nm region.

Methods and apparatus in accordance with embodiments of the present invention may provide advantages and benefits in the processing of soot preforms and manufacture of optical fiber and photomask or lens blanks. The bromine of the removal gas may remove chlorine from the soot preform without introducing new contaminants into the soot preform. By comparison, other methods for de-chlorinating a soot preform such as using an oxidizing flow of O₂ may undesirably reintroduce water and/or other impurities (e.g., from tramp material, contaminants, or impurities in the gas). The bromine-containing removal gas may remove chlorine more efficiently than an O₂ flow, for example, at desirable (i.e., relatively lower) process temperatures. The use of the bromine-containing removal gas may have little or substantially no adverse affect on the consolidated glass preform as all or nearly all of the bromine remaining in the de-chlorinated soot preform may be expelled during the sintering step. For example, the consolidated preform may contain less than 1% bromine by weight.

The reduction in chlorine in the soot preform may facilitate manufacture of the glass product and/or improve one or more performance characteristics of the glass product. The methods described herein may be particularly advantageous in processing an optical fiber preform doped with an alkali metal or other dopant that may be undesirably reactive with chlorine. Such dopants may form crystals in the glass that negatively affect the performance of the ultimate optical fiber. The methods of the present invention may also serve to eliminate or reduce excess chlorine in photomask blanks or other glass products that would otherwise negatively affect light transmission. Such reduction of chlorine may be particularly beneficial in the case of fused silica processing, and, in particular, for 157 nm and 193 nm photomasks and lenses.

While the methods and apparatus discussed above with reference to the embodiments of FIGS. 2 and 3 include drying steps and mechanisms using chlorine-containing drying gases, it will be appreciated that other embodiments of the invention may forego drying steps and mechanisms using chlorine-containing drying gases. For example, the removal process may be used to remove residual chlorine introduced by the soot deposition process or other processing.

While the methods and apparatus discussed above with reference to the embodiments of FIGS. 2 and 3 include a procedure for forming optical fiber wherein the portions corresponding to at least the core of the optical fiber are dried and de-chlorinated, it will be appreciated that other embodiments of the invention may include de-chlorinating only a soot preform corresponding to a cladding layer of an optical fiber using a bromine-containing removal gas.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

What is claimed is:

1. A method for processing a silica-containing soot article, comprising the step of:
exposing a silica-containing soot article to a removal gas including bromine such that the removal gas removes chlorine from the soot article.

2. The method of claim 1 including exposing the soot article to a chlorine-containing drying gas prior to exposing the soot article to the removal gas.

3. The method of claim 2 including:
forming the soot article using a vapor deposition process prior to exposing the soot article to the drying gas;
consolidating the soot article to form a consolidated glass preform following exposing the soot article to the removal gas; and thereafter drawing an optical fiber from the consolidated glass preform.

4. The method of claim 3 including diffusing an alkali metal into the consolidated glass preform prior to drawing the optical fiber from the consolidated glass preform.

5. The method of claim 2 wherein exposing the soot article to the drying gas includes exposing the soot article to the drying gas for a drying time of between about 30 and 300 minutes at a temperature within a range of from about 900 to 1200° C.

6. The method of claim 2 wherein the mole percentage of bromine present in the removal gas is at least about 0.1%.

7. The method of claim 1 wherein, following exposing the soot article to the removal gas, the soot article comprises less than about 500 ppm chlorine.

8. The method of claim 1 including consolidating the soot article to form a consolidated glass article following exposing the soot article to the removal gas.

9. The method of claim 8 wherein the consolidated glass article comprises no greater than about 1 weight % bromine.

10. The method of claim 8 including drawing an optical fiber from the consolidated glass article following consolidating the soot article.

11. The method of claim 10 including diffusing an alkali metal into the consolidated glass article.

12. The method of claim 11 wherein the alkali is selected from the group consisting of K, Na, Li, Cs, Rb, and combinations thereof.

13. The method of claim 11 including, following diffusing the alkali metal into the consolidated glass article:
forming a further layer of glass on the consolidated glass article to form a multilayer optical fiber preform including the consolidated glass article as a glass preform core or a portion of a core thereof; and thereafter
drawing an optical fiber from the multilayer glass article such that the glass preform core forms a core or a portion of a core of the optical fiber.

14. The method of claim 8 including forming a photomask or lens blank from the consolidated glass article.

15. The method of claim 1 including forming the soot article using a vapor deposition process prior to exposing the soot article to the removal gas.

16. The method of claim 1 wherein exposing the soot article to the removal gas includes exposing the soot article to the removal gas for a removal time of between about 30 and 300 minutes.

17. The method of claim 1 wherein exposing the soot article to the removal gas includes exposing the soot article to the removal gas at a temperature within a range of from about 900 to 1200° C.

18. The method of claim 1 including flowing the removal gas to the soot article within a chamber.

19. The method of claim 1 wherein the soot article is porous and has a density of less than about 1 g/cc.

20. The method of claim 1 wherein exposing the soot article to the removal gas includes reacting bromine of the removal gas with chlorine of the soot article to form at least BrCl.

21. The method of claim 1 wherein the mole percentage of bromine present in the removal gas is at least about 0.1%.

22. The method of claim 1 wherein the removal gas includes a bromine-containing compound selected from the group consisting of Br₂, SiBr₄, S₂Br₂, COBr₂, CBr₄, CHBr₃, CH₂Br₂, CH₃Br, and combinations thereof.

23. The method of claim 22 wherein the removal gas includes Br₂.
